(19) United States
(12) Patent Application Publication
(10) Pub. No.: US 2003/0212871 A1
(43) Pub. Date: Nov. 13, 2003

(54) Memory device and method of controlling the same

(75) Inventors: Hideaki Suzuki, Kawasaki (JP); Masaji Inami, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/393,974

(22) Filed: Mar. 24, 2003

(30) Foreign Application Priority Data
May 9, 2002 (JP) 2002-134111

(51) Int. Cl. G06F 12/14

(52) U.S. Cl. 711/164

(57) ABSTRACT

Provided is a memory device including a nonvolatile memory for storing data and a password in a designated address, a password comparison circuit for comparing an externally input first password with a second password stored in the nonvolatile memory, a volatile memory for storing authentication information indicating that access right establishment is authenticated, if the two passwords are found to be equal by the comparison, and an access control circuit for permitting external access to the nonvolatile memory only when the authentication information is stored in the volatile memory.

### CROSS-REFERENCE TO RELATED APPLICATIONS

This application is based upon and claims the benefit of priority from the prior Japanese Patent Application No. 2002-134111, filed on May 9, 2002, the entire contents of which are incorporated herein by reference.

### BACKGROUND OF THE INVENTION

1. Field of the Invention

The present invention relates to a memory device and method of controlling the same and, more particularly, to a memory device and method of controlling the same by which the access right to a nonvolatile memory is established by using a password.

2. Description of the Related Art

Recently, an information-oriented society has rapidly advanced, and large-capacity memory cards such as multi-purpose IC cards containing various applications are beginning to be used. So, it is of urgent necessity to secure the safety of saved information.

Although no memory cards seem to contain a security authentication mechanism, data saved in a nonvolatile memory such as a ferroelectric memory is nonvolatile and hence reusable. Accordingly, when this memory is incorporated into an apparatus, the possibility of a data leak is low. However, when the memory is used as an independent memory card, the saved data can be read out if the memory specification is simple. Also, an apparatus having a built-in memory can control external access by using a password. However, if the apparatus is so designed that data can be read out when the memory is directly accessed, the data may leak.

A leak of a password can be avoided by limiting access to an area where the password is saved. However, this password may be analyzed if a position where the password is saved is physically located. In addition, if there is only one password, this password may be destroyed by, e.g., an unexpected accident or changes with time. This may make access to the memory impossible.

Since the destruction of the password may make access to the memory chip impossible as described above, it is also possible to save a backup password file. These passwords can be updated for the sake of safety. However, if all the passwords are rewritten, they may be rewritten into an unintentional password owing to an unexpected accident or the like. If this occurs, no access to the memory chip is possible, and the result may be a blackout state.

The memory chip manufacturer can write a password when shipping the device from the factory. However, the memory chip manufacturer cannot easily change the password after the shipment from the factory and hence cannot rapidly respond to an accident. Also, the memory chip manufacturer cannot guarantee that the password does not leak.

### SUMMARY OF THE INVENTION

It is an object of the present invention to reliably revoke access authentication to a nonvolatile memory when power supply is shut down.

It is another object of the present invention to inhibit unauthorized access by analyzing a password block and confirm the stability of operation by changes in a memory device with time.

It is still another object of the present invention to avoid the possibility that the access right to a nonvolatile memory is lost by a human password rewrite error or a systematic write failure.

It is still another object of the present invention to make password analysis difficult by constantly changing the password by updating the password, registering a new password, and deleting an unnecessary password.

It is still another object of the present invention to simplify an authentication procedure which is performed a number of times, by lowering the security level with a time limit.

According to an aspect of the present invention, there is provided a memory device comprising a nonvolatile memory for storing data and a password in a designated address, a password comparison circuit for comparing an externally input first password with a second password stored in the nonvolatile memory, a volatile memory for storing authentication information indicating that access right establishment is authenticated, if the two passwords are found to be equal by the comparison, and an access control circuit for permitting external access to the nonvolatile memory only when the authentication information is stored in the volatile memory.

The memory device itself performs an access right authentication process using passwords. If the passwords match, authentication information indicating access right establishment is stored in the volatile memory, and external access is permitted. The volatile memory holds the stored authentication information when receiving power supply, and loses the authentication information when the power supply is shut down. Accordingly, after the power supply is shut down, no access is permitted, so high-level security control can be performed.

### BRIEF DESCRIPTION OF THE DRAWINGS

FIG. 1 is block diagram showing the arrangement of a memory device and terminal according to the first embodiment of the present invention;

FIG. 2 is a block diagram showing the configuration of the memory device according to the first embodiment;

FIG. 3 is a flow chart showing the procedure of a password authentication method;

FIG. 4 is a flow chart showing the process of preventing rewrite of an authenticated password;

FIG. 5 is a flow chart showing a new password setting procedure;

FIG. 6 is a flow chart showing an old password erasing procedure; and

FIG. 7 is a block diagram showing the configuration of a memory device according to the second embodiment of the present invention.

### DETAILED DESCRIPTION OF THE PREFERRED EMBODIMENTS

### First Embodiment

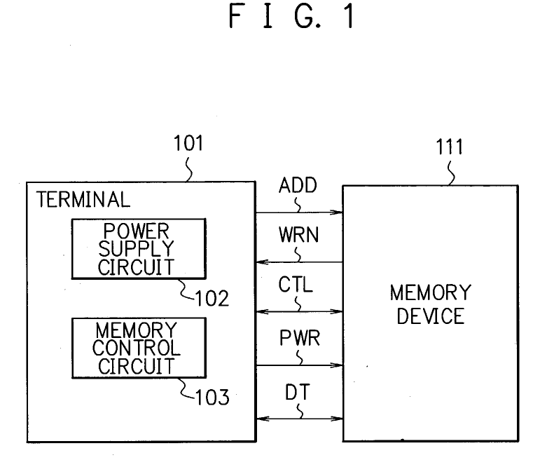

FIG. 1 shows a memory device 111 and terminal 101 according to the first embodiment of the present invention. This memory device 111 is a memory card or IC card which is used as, e.g., a telephone card or a ticket (pass) of a train. The terminal 101 has a power supply circuit 102 and memory control circuit 103 and can control the memory device 111. This terminal 101 is, e.g., a telephone or an automatic ticket gate. The power supply circuit 102 supplies power PWR to the memory device 111. The memory device 111 becomes operable when receiving this power PWR. The memory control circuit 103 outputs an address ADD and control signal CTL to the memory device 111, and exchanges data DT. The control signal CTL includes a chip enable signal, write enable signal, output enable signal, and the like. By using this control signal CTL, the terminal 101 can control write or read access to the memory device 111. For example, the memory device 111 and terminal 101 are connected when the memory device 111 is inserted into the terminal 101, and disconnected when the memory device 111 is removed from the terminal 101.

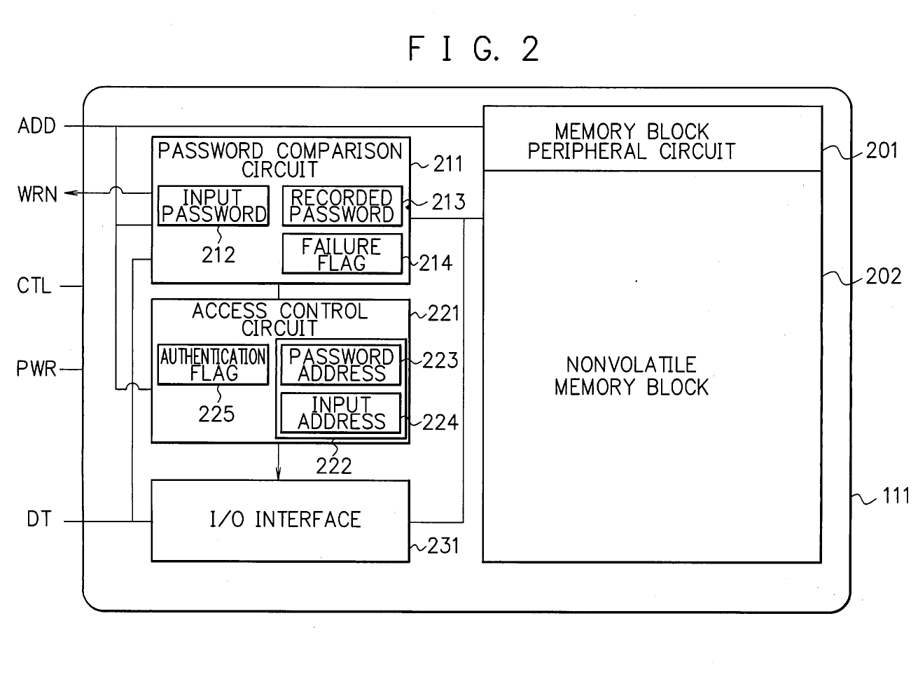

FIG. 2 is a block diagram showing the configuration of the memory device 111. A nonvolatile memory block 202 is, e.g., a ferroelectric memory and can store data and a password in a designated address ADD. In this nonvolatile memory block 202, a password is stored in a predetermined address in advance when the device is shipped from the factory. A memory block peripheral circuit 201 inputs the address ADD to specify an address in the nonvolatile memory block 202. A password comparison circuit 211 has an input password register 212, recorded password register 213, and failure flag 214. This password comparison circuit 211 compares an input password from the terminal 101 with the password stored in the nonvolatile memory block 202. An access control circuit 221 has an authentication flag 225 and address comparison circuit 222. The authentication flag 225 is a volatile memory. When the two passwords are found to be equal by the comparison by the password comparison circuit 211, this authentication flag 225 stores authentication information indicating that access right establishment is authenticated. Only when this authentication information is stored in the authentication flag 225, the access control circuit 221 outputs to an input/output (I/O) interface 231 a permission signal for permitting access from the terminal 101 to the nonvolatile memory block 202. The I/O interface 231 blocks data DT input to and output from the terminal 101 if no permission signal is input, and allows these data DT to pass through if a permission signal is input. More specifically, the I/O interface 231 disconnects or connects the path between the terminal 101 and nonvolatile memory block 202.

Also, the access control circuit 221 inhibits rewrite of an authenticated password. The address comparison circuit 222 has a password address register 223 and input address register 224. When receiving an instruction for write to the address ADD from the terminal 101 after the authentication information is stored in the authentication flag 225, the address comparison circuit 221 compares the authenticated password with the input address ADD. Only when the two addresses are different, the access control circuit 221 outputs to the I/O interface 231 a signal for permitting a write operation, which corresponds to the write instruction, to the nonvolatile memory block 202. Consequently, rewrite of the authenticated password can be prevented.

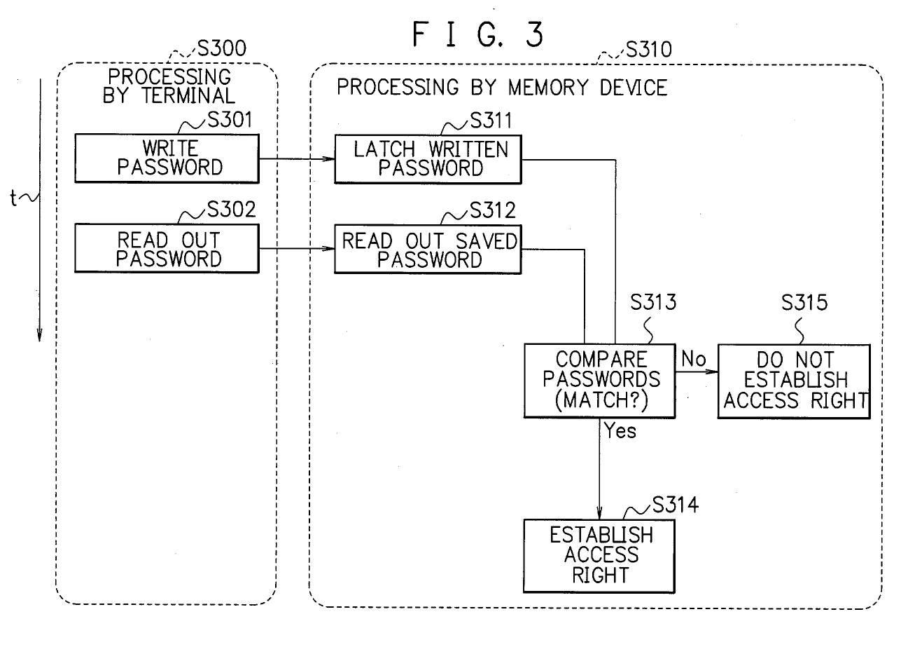

FIG. 3 is a flow chart showing the procedure of a password authentication method. Processing block S300 on the left-hand side is processing including steps S301 and S302 performed by the terminal 101. Processing block S310 on the right-hand side is processing including steps S311 to S315 performed by the memory device 111. A time axis t represents the direction along which the procedure progresses. For example, the following processing is performed when the memory device 111 is inserted into the terminal 101.

First, in step S301, the terminal 101 outputs a password write instruction to the memory device 111. This write instruction is a normal write instruction using a password as data DT.

In step S311, the password comparison circuit 211 latches this password as data DT in the input password register 212, since no authentication information is stored in the authentication flag 225. Note that no authentication information is initially stored in this authentication flag 225. If authentication information is stored in the authentication flag 225, the data DT is written in the designated address ADD of the nonvolatile memory block 202. On the other hand, if no authentication information is stored in the authentication flag 225, the access control circuit 221 outputs to the I/O interface 231 an inhibit signal for inhibiting access from the terminal 101 to the memory device 111. The I/O interface 231 stops the flow of the data DT from the terminal 101 to the nonvolatile memory block 202. As a consequence, the password as the data DT is not written in the nonvolatile memory block 202.

In step S302, the terminal 101 outputs to the memory device 111 an instruction for reading out the password from the address ADD. This read instruction is a normal read instruction for designating the address ADD.

In step S312, the password saved in the designated address ADD is read out as data from the nonvolatile memory block 202, and saved in the recorded password register 213. Since no authentication information is stored in the authentication flag 225, the access control circuit 221 outputs to the I/O interface 231 an inhibit signal for inhibiting access from the terminal 101 to the memory device 111. The I/O interface 231 stops outputting of the data DT from the nonvolatile memory block 202 to the terminal 101. Consequently, the memory device 111 does not output this password as the readout data DT to the terminal 101.

In step S313, the password comparison circuit 211 compares the password in the input password register 212 with the password in the recorded password register 231. That is, the password input by the write instruction is compared with the password read out by the read instruction. If the two passwords match, the flow advances to step S314. If the two passwords do not match, the flow advances to step S315.

In step S314, the password comparison circuit 211 outputs a matching signal to the access control circuit 221. In response to this matching signal, the access control circuit 221 records authentication information in the nonvolatile authentication flag 225, and outputs a permission signal to the I/O interface 231. This establishes the access right of the terminal 101. After that, the I/O interface 231 permits write and read accesses from the terminal 101. More specifically, the I/O interface 231 passes the flow of the data DT between the terminal 101 and nonvolatile memory block 202.

In step S315, the password comparison circuit 211 outputs no matching signal to the access control circuit 221. Therefore, no authentication information is yet stored in the authentication flag 225, so the access control circuit 221 outputs an inhibit signal to the I/O interface 231. The I/O interface 231 stops the flow of the data DT between the terminal 101 and nonvolatile memory block 202. Accordingly, no access right of the terminal 101 is established, so the terminal 101 cannot perform either write or read access to the memory device 111. Two methods are possible when the passwords do not match. In the first method, power supply from the terminal 101 to the memory device 111 is once turned off and then turned on again to redo the above processing. In the second method, the above processing is repeated while power supply is kept ON, and retry is permitted.

When access authentication to the memory device 111 is obtained as described above, authentication information is stored in the authentication flag 225. This authentication flag 225 is volatile, so information saved inside is lost when power supply is shut down. Therefore, even if someone attempts to access and analyze the memory device 111 after the power supply is turned off, the internal information of the nonvolatile memory block 202 cannot be acquired because no access right to the memory device 111 is established. If the mode of the internal operation of the memory device 111 is determined and formally authenticated by this authentication flag 225, a general access operation to the memory device 111 can be performed. If no operation mode is authenticated, the internal information is protected from being leaked to the outside of the memory device 111. Referring to FIG. 1, the I/O interface 231 prevents information leak to the outside. However, this information leak can also be prevented by another method.

Since no access can be performed for the internal nonvolatile memory block 202 until access authentication to the memory device 111 is acquired, the internal memory information is not destroyed even if a write operation is performed for the memory device 111. By using this feature, an access authentication procedure is performed for the memory device as described above. That is, the terminal 101 first writes data (a password) in the memory device 111 in a write mode. This data is saved in the input password register 212. Next, in a read mode, data (a password) is read out by designating an address in which this password is saved. Since no access authentication to the memory device 111 is not acquired yet as in the write operation, the readout data is not output to the outside of the memory device 111. The password written in the write mode and the password readout from the memory block 202 in the read mode are compared. If the two passwords match, access authentication information is written in the authentication flag 225. After that, write and read instructions to the memory block 202 become valid, so this memory block 202 can be used in the same manner as a general memory device.

When the memory device 111 is inserted into the terminal 101, power is supplied from this terminal 101 to the memory device 111, and a password authentication process is performed. After that, access to the memory block 202 is performed. When necessary processing is complete, the memory device 111 is removed from the terminal 101. When the memory device 101 is removed, this memory device 111 can no longer receive power supply from the terminal 101, so the contents of the authentication flag 225 disappear. Accordingly, when power supply to the memory device 111 is shut down, access right establishment can be reliably revoked. This prevents unauthorized analysis of the password and data in the memory device 111. Note that the nonvolatile memory block 202 holds the password and data stored inside without any power supply.

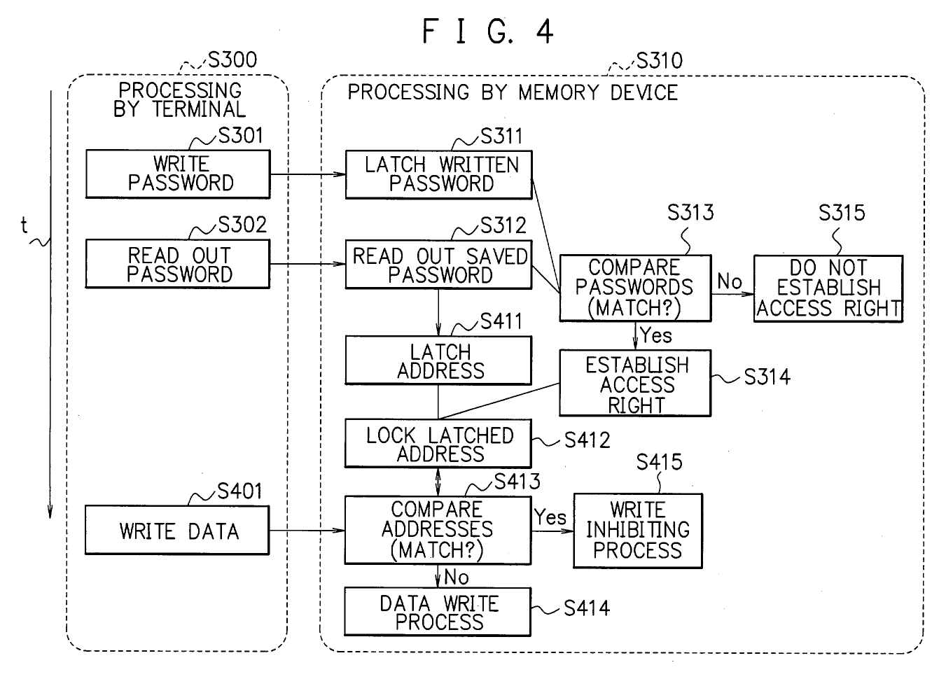

FIG. 4 is a flow chart showing the process of preventing rewrite of an authenticated password. This flow chart will be explained from part continued from the processing shown in FIG. 3.

In step S411, the address from which the password is read out in step S312 described above is latched in the password address register 223.

In step S412, after the access right is established in step S314 described above, the password address register 223 is locked to prevent a change in the address stored in this password address register 223.

In step S401, the terminal 101 outputs to the memory device 111 an instruction for writing data DT by designating an address ADD.

In step S413, the address ADD of the write instruction is written in the input address register 224. The address comparison circuit 222 compares the address in the input address register 224 with the address in the password address register 223. If the two addresses match, the flow advances to step S415. If the two addresses do not match, the flow advances to step S414.

In step S415, the access control circuit 221 outputs a write instruction inhibit signal to the I/O interface 231. The I/O interface 231 blocks the data DT, so this data DT is not written in the memory block 202. That is, rewrite of the authenticated password can be prevented.

In step S414, the access control circuit 221 outputs a write instruction permission signal to the I/O interface 231. The I/O interface 231 passes the data DT, so this data DT is written in the memory block 202. That is, data can be written in any address except for the address of the authenticated password.

Note that the method of inhibiting a write instruction is described above. However, it is also possible to inhibit a read instruction, as well as a write instruction, from the terminal 101.

A plurality of passwords can also be set in different addresses of the memory block 202. In this case, access right can be established by using any arbitrary one of the plurality of passwords. Of these passwords written in the memory device 111, a password for use in access right authentication is processed as an active password. While access authentication is valid with this password, this password cannot be overwritten. This prevents loss of the access right to the memory device by destruction of the password. To realize this, the address of the active password is saved in the password address register 223 when access authentication is performed. When a write instruction is executed for the memory device 111 after that, this address saved in the password address register 223 is compared with an address supplied from the terminal 101 to the memory device 111. If the two addresses are equal, data as the password is protected by inhibiting any write operation.

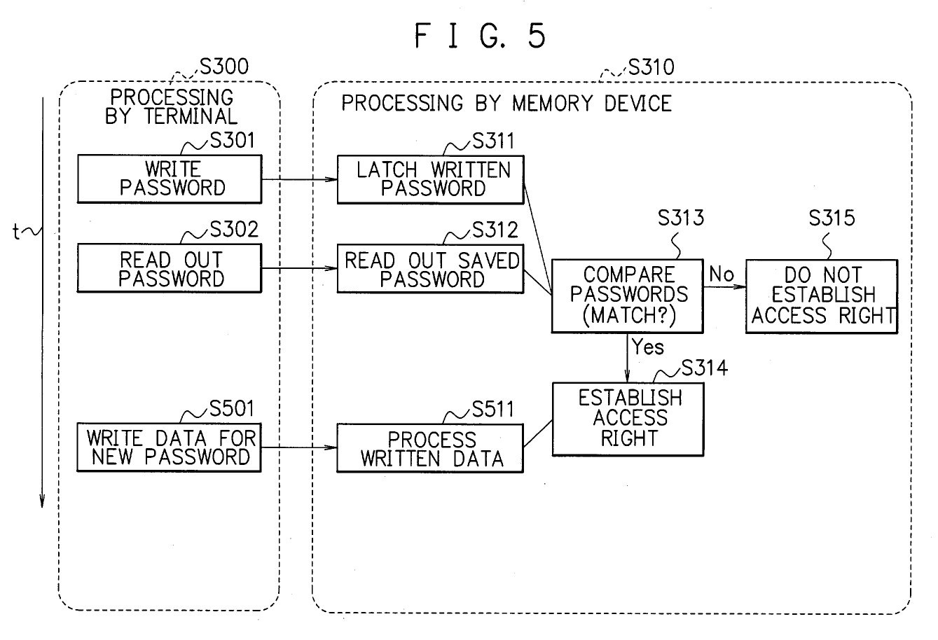

FIG. 5 is a flow chart showing a new password setting procedure. This flow chart will be explained below from the point at which the processing shown in FIG. 3 is complete.

After the access right is established, in step S501 the terminal 101 outputs to the memory device 111 an instruction for writing a new password as data DT in a predetermined address ADD. This write instruction is a normal write instruction. The address ADD must be different from the address of the authenticated password. As explained with reference to FIG. 4, write to the address of an active password is inhibited.

In step S511, the memory device 111 writes the address ADD of the write instruction in the input address register 224. Authentication information is already stored in the authentication flag 225. If the address in the input address register 224 and the address in the password address register 223 do not match, the access control circuit 221 outputs a permission signal to the I/O interface 231. The I/O interface passes the data DT. So, this data DT as a password is written in the address ADD of the memory block 202.

In this stage, the written password is merely data and hence can be overwritten. This data functions as a password only when this password is used in authentication. The new password can be used from the next password authentication. Accordingly, when a new password is written in the memory device 111 to which the access right is established and the access right to the memory device 111 is established again by using this password, the password becomes active. Since the initial password is not used in authentication, this password can be processed as simple data and hence can be changed or erased.

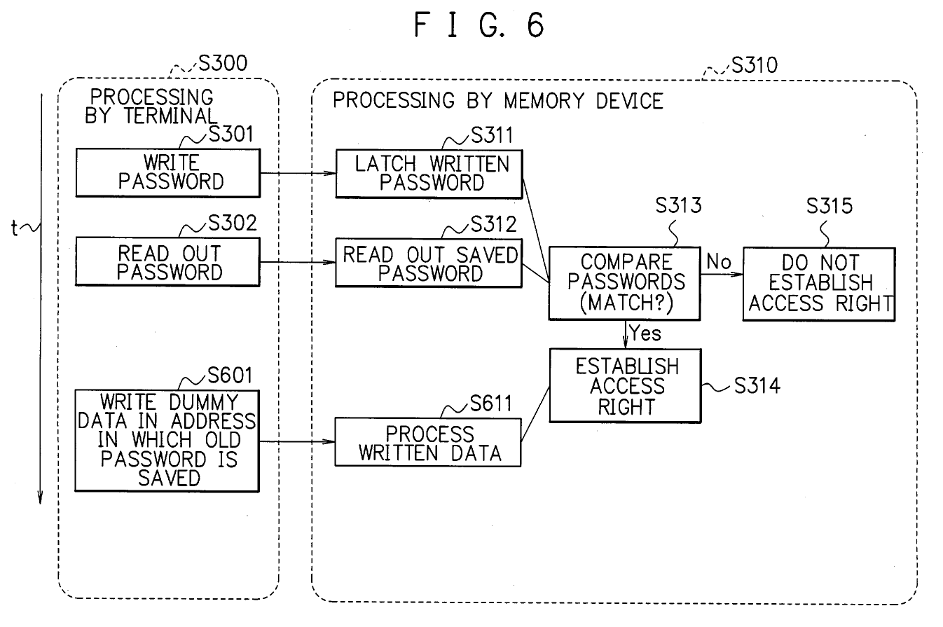

A password can be set in the memory block 202 when the memory device is shipped from the factory. This password is preferably changed because its secrecy is low. To change the password, the processing shown in FIG. 5 is first performed to write a new password in the memory block 202. Then, processing shown in FIG. 6 for erasing the old password is executed.

FIG. 6 is a flow chart showing the old password erasing procedure. This flow chart will be explained from the point at which the processing shown in FIG. 3 is complete. Assume that the access right is established by using a new password. That is, the terminal 101 outputs a new password write instruction in step S301, and outputs a new password read instruction in step S302. Consequently, the access right is established and the new password becomes active in step S314.

Next, in step S601, the terminal 101 outputs to the memory device Ill an instruction for writing an address ADD of the old password in dummy data DT. This write instruction is a normal write instruction.

In step S611, the address ADD of the write instruction is written in the input address register 224. Authentication information is already stored in the authentication flag 225. If the address in the input address register 224 and the address in the password address register 223 do not match, the access control circuit 221 outputs a permission signal to the I/O interface 231. The I/O interface 231 passes the data DT. The dummy data is written in the old password address in the memory block 202. This is substantially equivalent to erasing the old password.

Since the old password is not used in this access authentication, no access limit is imposed on the write instruction. Therefore, any arbitrary data can be overwritten on the old password data, so the old password can be erased. The old password can also be changed by a similar method. Analysis of a password can be made difficult by constantly changing the password by updating the password, registering a new password, and deleting an unnecessary password.

Assume that the memory device 111 controls the access right by using a password written when the device is shipped from the factory. For this memory device 111, the access right is established by using the password written when the device is shipped from the factory. After the access right is established, the memory device 111 can be freely accessed except for the password block used in authentication. Accordingly, a new password is set as shown in FIG. 5.

Subsequently, the access right is once canceled. The access right is canceled by, e.g., shutting down power supply from the terminal 101 to the memory device 111. After that, the access right is established for the memory device 111 again by using the newly set password. In this stage, the old password set when the device is shipped from the factory is no longer an active password, so there is no limitation on overwriting of this password. As shown in FIG. 6, therefore, this old password can be freely rewritten. In this way, it is possible to issue new passwords one after another and erase old passwords. Therefore, the password strength remains high even if the memory device 111 is used through a number of venders.

The nonvolatile memory block 202 is, e.g., a ferroelectric memory or flash memory and hence has a life caused by changes with time or the like. If there is only one password, this password may be destroyed by, e.g., an unexpected accident or changes with time. This may make access to the memory device 111 impossible. When a plurality of passwords are set, even if one password is destroyed the access right can be established by using another password. When the password is destroyed, password authentication fails. If password authentication has failed, a warning signal indicating that the life of the memory device 111 may have expired is output to the terminal 101.

More specifically, referring to FIG. 2, the password comparison circuit 211 compares the password in the input password register 212 with the password in the recorded password register 213. If the two passwords do not match, failure information is recorded in the nonvolatile failure flag 214 in step S315.

If access right establishment has failed, the terminal 101 performs the password authentication procedure again by using another password. When the access right is established by this procedure in step S314, the password comparison circuit 211 outputs a warning signal (mismatch signal) WRN to the terminal 101, if failure information is recorded in the failure flag 214, thereby clearing the failure flag 214. When receiving the warning signal WRN, the terminal 101 can perform processing, e.g., can issue a new memory device 111, since the life of the memory device 111 has expired.

When a plurality of passwords are written in the memory device 111 as described above, failure information is written in the failure flag 214 if password authentication is unsuccessful. Therefore, even when access right authentication is performed using a plurality of passwords, information indicating that the authentication is not normally performed with one of the passwords can be recorded. The value of this failure flag 214 can be used to monitor the state of the memory device 111 by outputting the value to the terminal 101. Accordingly, any unstable operation of the memory device 111 can be checked in early stages before a fatal hardware fault occurs.

### Second Embodiment

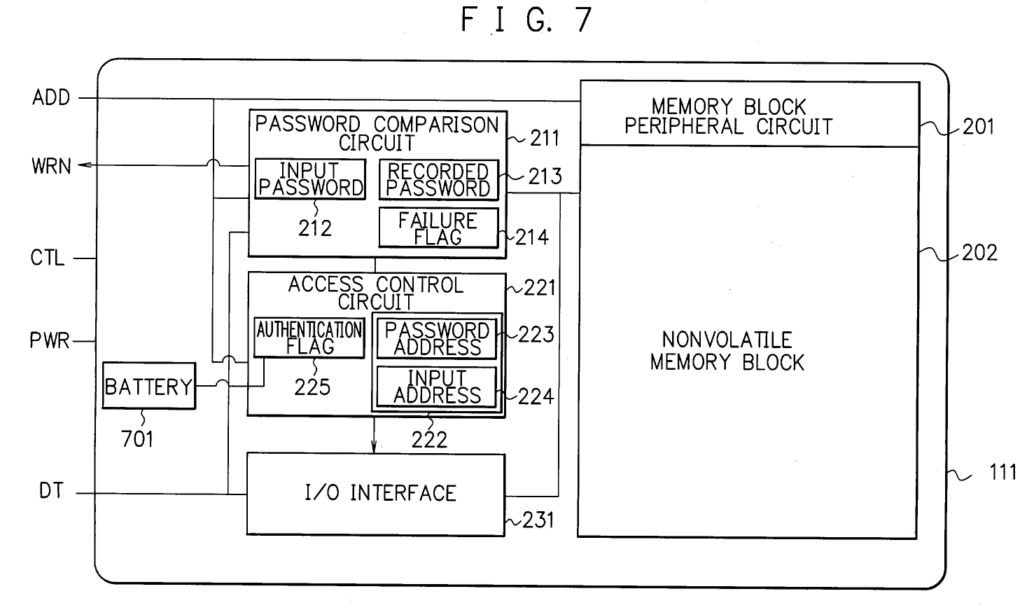

FIG. 7 is a block diagram showing the configuration of a memory device 111 according to the second embodiment of the present invention. This memory device 111 shown in FIG. 7 is obtained by adding a battery 701 to the memory device 111 shown in FIG. 2. The battery 701 supplies power for holding the stored contents of a volatile authentication flag 225, even when power supply from a terminal 101 is shut down. An authentication procedure can be simplified by using this battery 701 as an independent power supply for the authentication flag 225. Even if power supply from the terminal 101 to the memory device 111 is shut down, authentication information in the authentication flag 225 does not disappear. When a low security level is satisfactory, the ease with which the memory device 111 is used improves because a cumbersome password authentication procedure can be simplified.

One specific case is when this memory device 111 is used as a ticket of an amusement park, leisure land, or concert. In this case, a password authentication procedure need be performed only once when the user enters an amusement park. After that, whenever the user rides in a vehicle in the park, he or she inserts the memory device 111 as a ticket into the terminal 101 to perform a boarding procedure. This boarding process is performed a number of times in many cases, and the security level of the process can be relatively low. Therefore, only the boarding process need be performed during the boarding procedure by omitting the password authentication process.

If the memory device 111 shown in FIG. 1 is inserted into the terminal 101 when the user enters an amusement park, password authentication is performed, and the access right is established. However, when the admission procedure is complete and the memory device 111 is discharged from the terminal 101, no power is supplied any longer, so the contents of the authentication flag 225 disappear. In a boarding procedure after that, therefore, a boarding process must be performed after an authentication process is performed to establish the access right.

When the memory device 111 shown in FIG. 7 is used, even after the admission process is complete and the memory device 111 is discharged from the terminal 101, the contents of the authentication flag 225 are maintained by power supply from the battery 701. Accordingly, during a boarding procedure after that, only a boarding process need be performed by omitting a password authentication process.

Also, once an authentication procedure is performed, the memory device 111 can be used until power supply by the battery 701 stops. The life of the battery 701 means the available period of the memory device 111. When power supply by the battery 701 stops, authentication information in the authentication flag 225 disappears, so the access available period cannot be prolonged by intentionally replacing the battery.

In the first and second embodiments as described above, the memory device 111 itself performs an access right authentication process by using a password. By the use of the volatile authentication flag 225, the safety of data saved in the memory block 202 can be assured. If password authentication is unsuccessful, the warning signal WRN is output, so any unstable operation can be checked before the memory device 111 stops operating. This minimizes inconvenience such as a time loss caused by a failure of the memory device 111.

Since rewrite of a password used in authentication is inhibited, the means for obtaining the right of access to the memory device 111 does not disappear. This protects the memory device 111 from becoming unusable by password destruction caused by an unexpected accident or the like. In addition, the warning signal WRN is output if password authentication is unsuccessful. Therefore, a customer does not keep using the memory device 111 in an unstable state.

Also, a password can be saved in an arbitrary place, and an unnecessary (expired) password can be erased. Even when a password written when the device is shipped from the factory leaks, therefore, a customer can write a new password and erase the password written when the device is shipped from the factory. This maintains the security and keeps high tamper resistance.

The nonvolatile memory block 202 is, e.g., a ferroelectric memory, flash memory, phase transition memory, or MRAM (Magnetoresistance Random Access Memory). A ferroelectric memory or flash memory is preferable, and a ferroelectric memory is more preferable.

Each of the above embodiments shows only a practical example in practicing the present invention, so the technical scope of the present invention should not be limitedly interpreted by these embodiments. That is, the present invention can be practiced in various forms without departing from the technical idea and principal features of the invention.

As has been explained above, the memory device itself performs an access right authentication process using passwords. If the passwords match, authentication information indicating access right establishment is stored in the volatile memory, and external access is permitted. The volatile memory holds the stored authentication information when receiving power supply, and loses the authentication information when the power supply is shut down. Accordingly, after the power supply is shut down, no access is permitted, so high-level security control can be performed.

What is claimed is:

1. A memory device comprising:
a nonvolatile memory for storing data and a password in a designated address;
a password comparison circuit for comparing an externally input first password with a second password stored in said nonvolatile memory;
a volatile memory for storing authentication information indicating that access right establishment is authenticated, if the two passwords are found to be equal by the comparison; and
an access control circuit for permitting external access to said nonvolatile memory only when the authentication information is stored in said volatile memory.

2. The device according to claim 1, wherein said volatile memory holds the stored authentication information when receiving external power supply, and loses the authentication information when the external power supply is shut down.

3. The device according to claim 1, wherein when no authentication information is stored in said volatile memory, said password comparison circuit holds the first password without writing it in said nonvolatile memory upon receiving an external instruction for writing the first password, reads out the second password from a first address of said nonvolatile memory upon receiving an external instruction for reading out the first address of said nonvolatile memory, holds the second password without outputting it to the outside, and compares the first password with the second password.

4. The device according to claim 3, wherein when receiving an external instruction for writing data in a second address after the authentication information is stored in said volatile memory, said access control circuit compares the first address, in which the second password is stored, of said nonvolatile memory with the second address, and permits a write operation, which corresponds to the write instruction, to said nonvolatile memory only when the two addresses do not match.

5. The device according to claim 4, wherein when receiving an external instruction for writing a third password in a third address different from the first address in said nonvolatile memory after the authentication information is stored in said volatile memory, said access control circuit permits the third password to be written in the third address of said nonvolatile memory, as a new password which is valid from the next password authentication.

6. The device according to claim 1, wherein said nonvolatile memory stores a plurality of passwords in different addresses, and said password comparison circuit can compare, as a password, any of the plurality of passwords stored in said nonvolatile memory.

7. The device according to claim 6, wherein when receiving an external instruction for rewriting, of the plurality of passwords stored in said nonvolatile memory, a password in an address different from the address of the authenticated password, said access control circuit permits the rewrite of the password.

8. The device according to claim 1, wherein when receiving an external instruction for writing data in a first address after the authentication information is stored in said volatile memory, said access control circuit compares a second address, in which the second password is stored, of said nonvolatile memory with the first address, and permits a write operation, which corresponds to the write instruction, to said nonvolatile memory only when the two addresses do not match.

9. The device according to claim 1, wherein said password comparison circuit outputs a mismatch signal to the outside when the two passwords do not match.

10. The device according to claim 1, further comprising a battery for holding the stored contents of said volatile memory.

11. A memory device control method comprising the steps of:
(a) when receiving an external instruction for writing a first password in a nonvolatile memory, holding the first password without writing it in the nonvolatile memory;
(b) when receiving an external instruction for reading out a first address of the nonvolatile memory, reading out a second password from the first address in the nonvolatile memory, and holding the second password without outputting it to the outside;
(c) comparing the first and second passwords;
(d) if the two addresses are found to be equal by the comparison, storing, in a volatile memory, authentication information indicating that access right establishment is authenticated; and
(e) permitting external access to the nonvolatile memory only when the authentication information is stored in the volatile memory.

12. The method according to claim 11, wherein the volatile memory holds the stored authentication information when receiving external power supply, and loses the authentication information when the external power supply is shut down.

13. The method according to claim 11, wherein when receiving an external instruction for writing data in a second address after the authentication information is stored in the volatile memory, the step (e) comprises comparing the first address, in which the second password is stored, of the nonvolatile memory with the second address, and permits a write operation, which corresponds to the write instruction, to the nonvolatile memory only when the two addresses do not match.

14. The method according to claim 13, wherein when receiving an external instruction for writing a third password in a third address different from the first address in said nonvolatile memory after the authentication information is stored in the nonvolatile memory, the step (e) comprises permitting the third password to be written in the third address of the nonvolatile memory, as a new password which is valid from the next password authentication.

15. The method according to claim 11, wherein the nonvolatile memory stores a plurality of passwords in different addresses, and the step (c) comprises being able to compare, as a password, any of the plurality of passwords stored in the nonvolatile memory.

16. The method according to claim 11, wherein when receiving an external instruction for rewriting, of the plurality of passwords stored in the nonvolatile memory, a password in an address different from the address of the authenticated password, the step (e) comprises permitting the rewrite of the password.

17. The method according to claim 11, further comprising the step (f) of outputting a mismatch signal to the outside if the two passwords do not match in the step (c).
